(19) United States
(12) Patent Application Publication
(10) Pub. No.: US 2010/0199400 A1
(43) Pub. Date: Aug. 12, 2010

(54) LIQUID CONTAINER SUSPENSION APPARATUS

(76) Inventor: Michael Brandon Graffeo, Denver, CO (US)

Correspondence Address: BRADLEY ARANT BOULT CUMMINGS LLP, 200 CLINTON AVE. WEST, SUITE 900, HUNTSVILLE, AL, 35801, US

(21) Appl. No.: 12/701,985

(22) Filed: Feb. 8, 2010

Related U.S. Application Data
(60) Provisional application No. 61/151,716, filed on Feb. 11, 2009.

(51) Int. Cl. A41B 13/10; A61J 9/06

(52) U.S. Cl. 2/49.1; 248/102

(57) ABSTRACT

A child's bib including the following elements is provided: a collar further comprising a left side and a right side, said left and right sides capable of being reversibly connected by one or more hook-and-loop closures; a main body located below the collar and above a folding section connected to a vertical member; liquid container receiver further comprising a left arm, a right arm, a lower portion and one or more liquid container securing elements, said liquid container receiver forming a structure for receiving a liquid container; and wherein the bib is constructed from a 8 oz canvas laminated with non-phthalate containing PVC.

### CROSS-REFERENCE TO RELATED APPLICATIONS

This application claims priority from U.S. Provisional Application No. 61/151,716 filed Feb. 11, 2009 entitled “Liquid Container Suspension Apparatus.”

### FIELD OF INVENTION

The present disclosure relates to an apparatus that is easily and safely secured around the neck of an user thereby enabling the user to feed oneself from a liquid container while reducing or eliminating spills, drops and associated container contamination.

### BACKGROUND ART

Protective bibs have long been available to shield a child's clothing from spills during feeding. However, the busy, on-the-go lifestyle of modern day parents has created a need to effectively enable children to independently feed themselves from a liquid container in environments both inside and outside the home, including but not limited to in cars, restaurants, high chairs, car seats and strollers, while the parent is supervising, but otherwise engaged. Comparable scenarios often result in the child dropping, throwing or overturning the liquid container, which causes spills on the child's clothing and/or the surrounding location, compromises the cleanliness of the liquid container and frustrates both the parent and the child. Therefore, an apparatus that is easily and safely secured around the neck of a child thereby enabling the child to feed herself from a liquid container while reducing or eliminating spills, drops and associated container contamination would significantly increase the efficiency of this everyday task.

### BRIEF DESCRIPTION OF DRAWINGS

To further advantages and features of the present disclosure, a more particular description of the invention will be rendered by reference to specify embodiments thereof which are illustrated in the appended drawings. It should be noted that identical features in different drawings are shown with the same reference numeral.

FIGS. 1A, 1B, 1C, 1D and 1E show front and rear views of various embodiments of the present disclosure.

FIGS. 2A and 2B show front views of two embodiments of the present disclosure around the neck of a child.

FIGS. 3A and 3B show various embodiments of securing a liquid container in the liquid container receiver of the present disclosure.

### SUMMARY OF INVENTION

In one aspect, an apparatus for receiving a liquid container comprising: a collar; a folding section; and a liquid container receiver is provided. In some aspects, the collar further includes a right side and a left side reversibly connected by at least one fastener or one non-separating piece of material comprising a opening fitable over an user's head. In another aspect, the apparatus includes a vertical element.

In yet other aspects, a child's bib comprising: a collar further comprising a left side and a right side, said left and right sides capable of being reversibly connected by one or more hook-and-loop closures; a main body located below the collar and above a folding section connected to a vertical member; liquid container receiver further comprising a left arm, a right arm, a lower portion and one or more liquid container securing elements, said liquid container receiver forming a structure for receiving a liquid container; and wherein the bib is constructed from a 8 oz canvas laminated with non-phthalate containing PVC.

### DETAILED DESCRIPTION

The current application discloses a versatile apparatus that overcomes many of the problems associated with teaching a child to feed herself from a liquid container such as a bottle or a “sippy cup”. The apparatus should be capable of being easily and safely secured around the neck of a child thereby enabling the child to feed herself from a liquid container while eliminating or reducing spills, drops and associated container contamination. The apparatus also allows a child to remain mobile. The apparatus should provide the child ample flexibility to feed herself while retaining a liquid container in a comfortable and accessible position during both feeding and rest. Further the apparatus may be relatively inexpensive/disposable and/or easy cleaned for re-use.

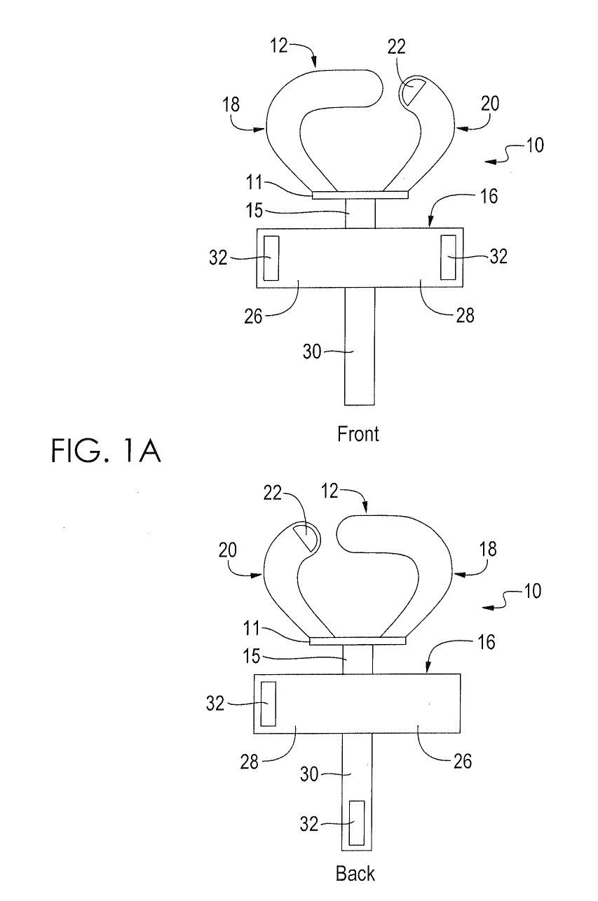

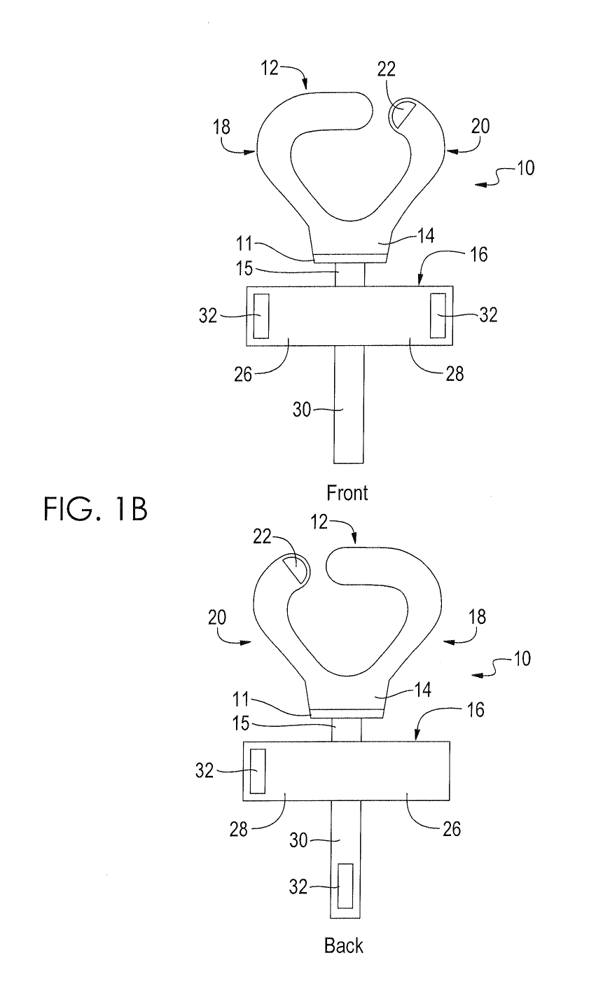

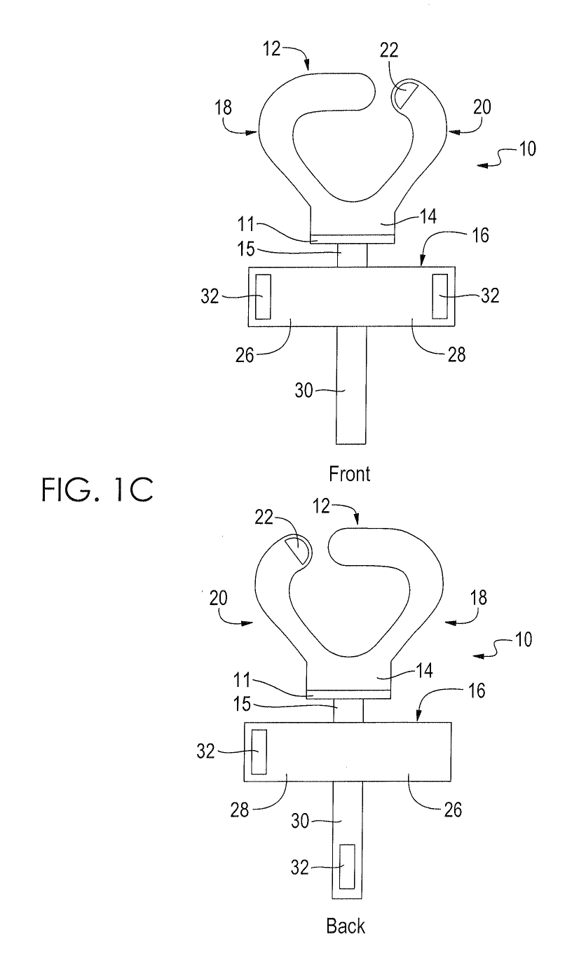

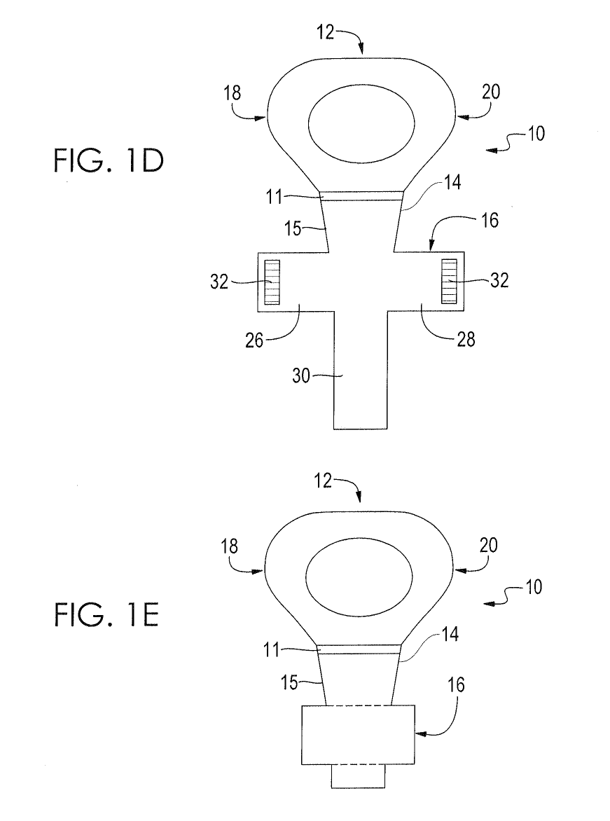

Various embodiments of the invention are shown in FIGS. 1A-1E. One embodiment of the invention is shown in FIG. 1A. In FIG. 1A, the bib 10 includes a collar element 12, a folding element 11, a vertical member 15 and a liquid container receiver 16. Generally, the collar element 12 safely secures the bib 10 around a child's neck. The folding element 11 shapes the downward arc of the vertical member 15 in order to prevent the vertical member 15 from buckling up towards the child's chin and face while drinking from the liquid container (not shown) thereby helping to protect the child's clothing from spills, increasing the comfort of the bib 10 and efficacy of the feeding. The vertical member 15 must be of sufficient length for the liquid container to lie comfortably below the child's chin when not consuming from the liquid container (not shown). As one skilled in the art would realize, the length of the vertical member 15 will likely be different for different aged wearers. Generally, the folding element 11 and the vertical member 15 are located between the collar element 12 and the liquid receiver 16 with the folding element 11 located above the vertical member 15. The liquid container receiver 16 provides a flexible and secure fit for various liquid containers while retaining the integrity to maintain the liquid container in an upright or nearly upright manner as to decrease or eliminate spills, drops and associated container contamination.

Still referring to FIG. 1A, in some embodiments of the bib 10, the collar element 12 includes a left collar portion 18, a right collar portion 20 and one or more collar fastening devices 22. In FIG. 1A, the left collar portion 18 and right collar portion 20 together form a C-shaped element which fits safely and comfortably around a child's neck. In the embodiment shown in FIG. 1A, the collar element includes collar fastening devices 22 which may be a hook and loop type fastening mechanism (such as Velcro). Other fastening devices 22 within the scope of this disclosure include snaps or ties although other fastening means are considered within the scope of this disclosure. In other embodiments (not shown) the collar element 12 may be one continuous loop of material having an opening within the body of the bib 10 so that the bib 10 can slide down over the child's head. In yet a further embodiment (not shown), the collar element 12 may be flexibly opened to receive the neck of a wearer having an inner border adjacent to the neck opening which may be elasticized to allow the occurrence of a snug, yet comfortable fit wherein the flexible hoop is made from a memory material that, subsequent to expanding, will naturally contract to its original shape and size as are well known in the art.

In one embodiment, the liquid container receiver 16 includes a left arm 26, a right arm 28, a lower portion 30 and one or more liquid container securing elements 32. In the embodiments shown in FIGS. 1A, 1B and 1C the liquid container securing elements 32 may be a hook and loop type fastening mechanism (such as Velcro). Other liquid container securing elements 32 such as snaps or ties are considered within the scope of this disclosure as well. The left arm 26, right arm 28 and lower portion 30 when fastened together form a generally concave structure which provides a flexible and snug fit for various liquid containers, including without limitation baby bottles, “sippy cups”, cans, juice boxes, cups and bottles. In some embodiments, the liquid container receiver 16 includes a slip resistant material (not shown) which contacts the liquid container (not shown) and provides friction thereby better securing the liquid container (not shown) inside the liquid container receiver 16. In some embodiments, the slip resistant material (not shown) may contact the liquid container (not shown) on multiple sides while in other embodiments the slip resistant material (not shown) may only contact the liquid container (not shown) on one side.

Now referring to FIGS. 1B and 1C, in some embodiments, the bib 10 includes a main body element 14 located below the collar element 12 and above the folding element 11 which provides protection against spills from the liquid container by providing a barrier between the child's clothing and the liquid. In such embodiments, the main body element 14 is designed to cover a portion of the child's clothing (i.e., the main body element 14 would have a larger surface area). In other embodiments, the main body element 14 provides only minimal protection to the clothing from spills (i.e., the main body element 14 has a small surface area). In one embodiment shown in FIG. 1B, the main body element 14 is angled from its widest point connected to the collar element 12 to its narrowest point connected to the folding element 11. In yet another alternate embodiment shown in FIG. 1C, the main body element 14 is essentially square maintaining roughly the same dimensions from the collar element 12 to the folding element 11.

In an embodiment including a main body element 14, the folding element 11 and vertical member 15 are still present. As before, the folding element 11 shapes the downward arc of the main body 14 and vertical member 15 in order to prevent them from buckling up towards the child's chin and face while drinking from the liquid container (not shown) thereby helping to protect the child's clothing from spills, increasing the comfort of the bib 10 and increasing the efficacy of the feeding.

In the embodiment shown in FIGS. 1D and 1E, the folding element 11 is located below the collar 12 and above the main body 14. The folding element 11 may be narrower than the main body 14 in some embodiments or it may be wider.

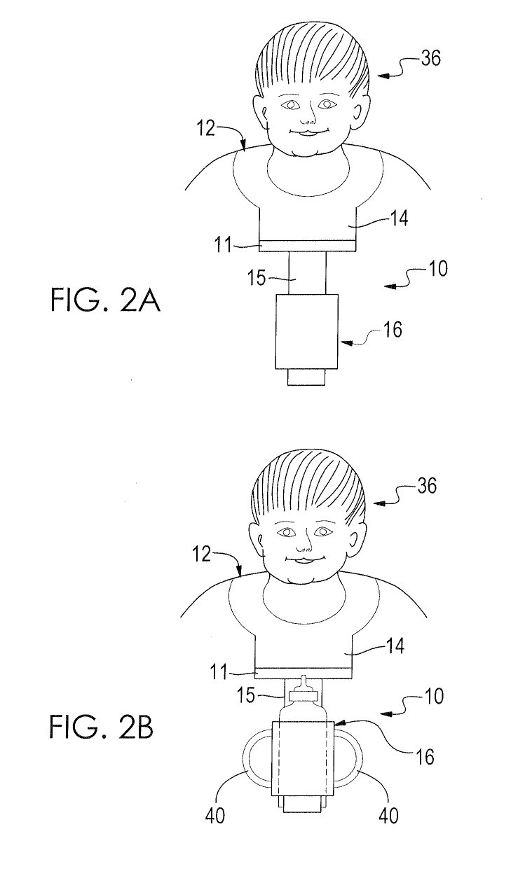

FIGS. 2A and 2B shows two embodiments of the bib 10 placed onto the neck of a child 36. Generally, the collar element 12 is secured around the child's 36 neck. It is important that the fastening device 22 (not shown in FIG. 2A or 2B) be of adequate design as to prevent posing any hazard to the child.

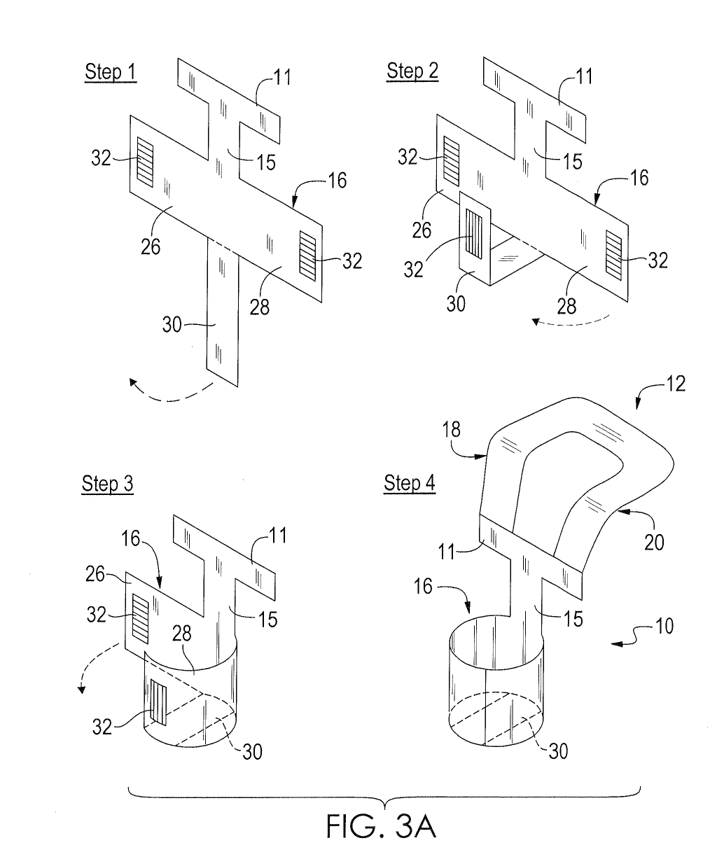

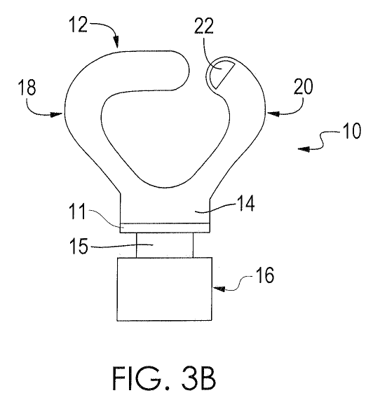

FIG. 3A shows one embodiment of securing a liquid container (not shown) in the liquid container receiver 16. There are many methods to secure the liquid container in the liquid container receiver 16. In one embodiment, the liquid container receiver 16 steps are as follow: in Step 1, the lower portion 30 is wrapped along the bottom and front of the liquid container (not shown). Next, in Step 2, the right arm 28 is wrapped around the liquid container and secured by the liquid container securing elements 32 to the lower portion 30. Finally, the left arm 26 is wrapped around the liquid container (not shown) and secured using the liquid container securing elements 32 to the right arm 28. Step 4 shows one embodiment of the bib 10 completely assembled. Other methods of securing and/or placing the liquid container in the liquid container receiver 16 are considered within the scope of this invention.

FIG. 3B shows another embodiment of the bib 10 and liquid container receiver 16. In this embodiment, the liquid container receiver 16 is generally pre-shaped to accept a liquid container (not shown) and the liquid container receiver 16 is not formed by the steps described in paragraph 18 above.

In yet another alternate embodiment, the liquid container receiver 16 is insulated as to provide a temperature regulating means to maintain drink temperature after the drink is secured within the liquid receiver. Accordingly, in this embodiment the liquid container receiver 16 will keep a hot drink hot/warm for a period of time and a cold drink cold/cool for a period of time.

In some embodiments, as shown in FIG. 2B the liquid container receiver 16 includes one or more handles 40 attached to the left and right arms 26, 28. These handles allow the user to lift the liquid receiver 16 and the liquid container therein to the user's mouth for drinking. In another embodiment, the liquid container receiver 16 includes one or more openings which will receive the handles of a sippy cup and allow a child to grasp said handles and use the sippy cup in its intended manner.

A strap (not shown), as is well known in the art, may be provided for the purpose of maintaining attachment of a pacifier, teething ring or other suitable toy (not shown) to the main body element 14, the collar element 12 or the vertical member 15 of the bib 10. In alternate embodiments, the bib 10 may include a crumb catcher (not shown) to trap solid crumbs and make the disposal thereof more efficient.

Alternate uses of the bib 10 are contemplated as within the scope of this disclosure. One such use is to suspend a beverage at a convenient and acceptable location for an adult which will allow the adult to keep their hands free for other activities while being able to drink their beverage easily. In another embodiment, the bib 10 may be used for elderly persons who have a hard time lifting and drinking from glasses due to arthritis or other medical conditions.

The bib 10 may be manufactured from any number of materials. In some embodiments the bib 10 is designed to be reusable and therefore is easy to clean, while in other embodiments the bib 10 may be designed to be disposable (i.e., used only once). If the bib 10 is disposable, it may be made of materials commonly known to be suitable for such purposes. In one embodiment, the front of the bib 10 may include a cotton or other knit material while the back of the bib 10 (that contacts the child) may include flannel. In one embodiment, the child facing portion of the bib 10 is the same fabric as the outer facing portion and includes same or different print and/or design. In another embodiment, the child facing portion of the bib 10 is a different fabric, print and/or design than the outer facing portion thereby giving the bib 10 a reversible appearance and use.

In one embodiment the bib 10 is made from a woven fabric cloth that is washable, durable and flexible. In other embodiments, a synthetic material may be employed which is impervious to liquids thereby providing a barrier between the liquid contained in the liquid container and the child's clothing. The synthetic material may be a film-forming polymeric material. In one embodiment, the bib 10 may be manufactured so that it is “reversible” in that the bib 10 has a first fabric with a first print on a front side and a second fabric with a second print on the rear. In one particular embodiment, the bib 10 is constructed of 1 mil polyurethane film and a fabric. In a further embodiment, the 1 mil polyurethane film is laminated onto the fabric. In a further embodiment, the fabric is 8 oz canvas which is laminated with non-phthalate containing PVC (Poly Vinyl Chloride).

In some embodiments the bib 10 may include two or more layers of material where the outmost layer is impervious to liquid while the inner most layer which rests against the child may be a softer material such as terry cloth, flannel or cotton. In one embodiment, the inner most layer is constructed from 1 mil polyurethane film and a fabric. In yet other aspects the bib 10 may be manufactured to have a layer of absorbent matrix sandwiched between an outer and an inner layer. The absorbent matrix may be a superabsorbent polymer (SAP). SAPs are polymers that can absorb and retain large amounts of a liquid relative to their own mass.

In other embodiments the bib 10 may include one or more anti-infective agents to keep bacteria and other infectious agents from growing on the bib 10. The bib 10 of the present disclosure designed for use with an infant may have a different combination of anti-infective agents than a bib 10 designed for use with a toddler. The anti-infective agent may be a cytostatic or a cytotoxic agent. “Infective agent” as used herein means any known agent that is capable of negatively impacting the health of a child such as, but not limited to, any agent capable of causing an infection; such organisms include, but are not limited to, bacteria (both gram positive and gram negative), viruses, parasites and fungi. The anti-infective agent may be an alcohol, an aldehyde, a halogen-releasing compound, a peroxide, an anilide, a biguanide, a bisphenols, a halophenol, a heavy metal, a phenol or cresol, a quaternary ammonium compound.

In a specific embodiment, the anti-infective agent is triclosan (5-chloro-2-(2,4-dichlorophenoxy)phenol). In another specific embodiment, the anti-infective agent is 2-propanol (available under the trade name Microban).

The bib 10 may be constructed by methods commonly known in the art including sewing, gluing, melding or other processes. In some embodiments the bib 10 may be constructed by the addition of heat to allow the different components to meld together.

While the invention has been described with respect to a limited number of embodiments, those skilled in the art, having benefit of this disclosure, will appreciate that other embodiments can be devised which do not depart from the scope of the invention as disclosed here.

What is claimed is:

1. A child's bib comprising:
a. a collar further comprising a left side and a right side, said left and right sides capable of being reversibly connected by one or more hook-and-loop closures;
b. a main body located below the collar and above a folding section connected to a vertical member;
c. liquid container receiver further comprising a left arm, a right arm, a lower portion and one or more liquid container securing elements, said liquid container receiver forming a structure for receiving a liquid container; and
d. wherein the bib is constructed from a 8 oz canvas laminated with non-phthalate containing PVC.

2. The bib of claim 1 further comprising an anti-infective agent.

3. An apparatus for receiving a liquid container comprising:
a. a collar;
b. a folding section; and
c. a liquid container receiver.

4. The apparatus of claim 3 wherein the collar further comprises a right side and a left side reversibly connected by at least one fastener.

5. The apparatus of claim 3 wherein the collar further comprises one non-separating piece of material comprising a opening fitable over an user's head.

6. The apparatus of claim 3 further comprising a vertical member.

7. The apparatus of claim 3 where the liquid container receiver further comprises a left arm, a right arm and a lower portion.

8. The apparatus of claim 7 where the liquid container receiver further comprises one or more container securing elements.

9. The apparatus of claim 8 where the one or more container securing elements is a hook-and-loop fastener.

10. The apparatus of claim 3 where the liquid container receiver further comprises a slip-resistant material.

11. The apparatus of claim 3 where the liquid container receiver is adapted to receive a drink container.

12. The apparatus of claim 3 where the liquid container receiver further comprising a handle.

13. The apparatus of claim 3 further comprising a main body.

14. The apparatus of claim 3 further comprising 1 mil Polyurethane Film and Polyester Interlocked Fabric.

15. The apparatus of claim 3 further comprising 8 oz canvas and Poly-Vinyl Chloride.

16. The apparatus of claim 3 further comprising an anti-infective agent.

17. The apparatus of claim 7 where the left arm, a right arm and a lower portion are reversibly adaptable to receive liquid containers of varying size, shape and volume.

18. The apparatus of claim 3 further comprising a SAP.
